(19) United States
(12) Patent Application Publication
(10) Pub. No.: US 2012/0134540 A1
(43) Pub. Date: May 31, 2012

(54) METHOD AND APPARATUS FOR CREATING SURVEILLANCE IMAGE WITH EVENT-RELATED INFORMATION AND RECOGNIZING EVENT FROM SAME

(75) Inventors: Jin Hee HAN, Daejeon (KR); Hong Il Ju, Daejeon (KR); Sugll Choi, Daejeon (KR); Geonwoo Kim, Daejeon (KR); Min-ho Han, Daejeon (KR); Su Wan Park, Daejeon (KR); Yong-Sung Jeon, Daejeon (KR); Moo Seop Kim, Daejeon (KR); Young Sae Kim, Daejeon (KR); Jong-Wook Han, Daejeon (KR)

(73) Assignee: ELECTRONICS AND TELECOMMUNICATIONS RESEARCH INSTITUTE, Daejeon (KR)

(21) Appl. No.: 13/305,842

(22) Filed: Nov. 29, 2011

(30) Foreign Application Priority Data
Nov. 30, 2010 (KR) 10-2010-0120213

(51) Int. Cl. G06K 9/00

(52) U.S. Cl. 382/103

(57) ABSTRACT

An apparatus for creating a surveillance image with event-related information includes an event detection unit configured to detect an event in the surveillance image, an encoding unit configured to encode the surveillance image into a bit stream of the surveillance image, an event information creation unit configured to create event-related information based on the detected event, and a parsing unit configured to parse the encoded surveillance image and insert the event-related information into the bit stream of the encoded surveillance image.

### CROSS-REFERENCE TO RELATED APPLICATION(S)

The present invention claims priority of Korean Patent Application Nos. 10-2010-0120213, filed on Nov. 30, 2010, which is incorporated herein by reference.

### FIELD OF THE INVENTION

The present invention generally relates to a technique for detecting events in an intelligent monitoring system; and, more particularly, to an apparatus and method for creating a surveillance image with event-related information, and an apparatus and method for recognizing an event from the surveillance image by using a supplemental enhancement information (SEI) field.

### BACKGROUND OF THE INVENTION

As is well known, event information, extracted from an image recognition unit or an event detection module of an intelligent monitoring system or intelligent security system, has been used to previously detect and defends various types of dangerous situations, such as the invasion of restricted areas by an outsider, stolen valuables, vehicle accidents, child kidnapping, fire alarms, and flooding, which may occur in the living environment.

FIG. 1 is a block diagram of an apparatus for use in an intelligent monitoring system, which extracts and stores event-related information from a surveillance image, in accordance with a related art. The apparatus includes an event detection unit 102, an encoding unit 104, an event information creation unit 106, an event DataBase (DB) 108, and an integrated management server 110.

Referring to FIG. 1, when a surveillance image of a surveillance area is received from a video camera or a Digital Video Recorder, the event detection unit 102 detects and extracts an event from the received surveillance image. Information on the extracted event is delivered to the event information creation unit 106, and the surveillance image is provided to the encoding unit 104.

The encoding unit 104 encodes the received surveillance image in conformity with a preset encoding format, for example, the H.264 video format or the Moving

Picture Experts Group (MPEG) video format. The encoded surveillance image is transmitted to the integrated management server 110 in the form of a bit stream via a transmission channel CH1.

The event information creation unit 106 allows event-related information to store in the event DB 108. Further, the event information creation unit 106 converts the event-related information into the form of a header file or metadata and transmits the converted event-related information along with the bit stream of the encoded surveillance image to the integrated management server 110 via the channel CH1, or transmits them to the integrated management server 110 via a separate transmission channel CH2.

The integrated management server 110 searches for event-related information by performing the conversion of the event-related information and the decoding of the bit stream, recognizes situations related to an event using the event-related information stored in the DB.

As described above, however, the conventional scheme of storing and searching for event-related information has the problem of requiring a separate operating scheme capable of managing metadata because event information extracted from images is included in a separate specific header file and then stored in a storage device and the event information is generated in the form of meta data by combining various types of information. In addition, the conventional scheme has the problem of requiring a large amount of expense and time in order to construct such a system because an integrated management server also should construct an additional operating scheme.

Further, in order to extract the event-related information or to insert additional information required by a user into the event-related information, a format of encoded surveillance image should be converted into another format and only images or files in conformity with a specific compression scheme should be considered to achieve it.

### SUMMARY OF THE INVENTION

In view of the above, the present invention provides an apparatus and method for creating a surveillance image with event-related information, and an apparatus and method for recognizing an event from the surveillance image by using a supplemental enhancement information (SEI) field.

In accordance with a first aspect of the present invention, there is provided an apparatus for creating a surveillance image with event-related information, the apparatus including:

an event detection unit configured to detect an event in the surveillance image;

an encoding unit configured to encode the surveillance image into a bit stream of the surveillance image;

an event information creation unit configured to create event-related information based on the detected event; and

a parsing unit configured to parse the encoded surveillance image and insert the event-related information into the bit stream of the encoded surveillance image.

In accordance with a second aspect of the present invention, there is provided a method for creating a surveillance image with event-related information, the method including:

detecting an event in a surveillance image using an intelligent image recognition technique;

encoding the surveillance image to produce a bit stream of an encoded surveillance image;

parsing the encoded surveillance image; and

inserting event-related information corresponding to the event into the bit stream of the encoded surveillance image.

In accordance with a third aspect of the present invention, there is provided an apparatus for recognizing an event form a surveillance image, the apparatus including:

a parsing unit configured to parse the surveillance image to determine whether or not there exists a Supplemental Enhancement Information (SEI) field in the surveillance image;

an event recognition unit configured to recognize the event in the surveillance image based on the SEI; and

a display control unit configured to display event-related information corresponding to the event on a monitor together with the surveillance image.

In accordance with a fourth aspect of the present invention, there is provided a method for recognizing an event from a surveillance image, the method including:

receiving a bit stream of a surveillance image;

checking whether or not there exists a SEI field having event-related information in the surveillance image;

when the SEI field exists, extracting the event-related information from the SEI field

to recognize the event that has been detected in the surveillance image based on the event-related information.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram of an apparatus for use in an intelligent monitoring system, which extracts and stores event-related information from a surveillance image, in accordance with a related art;

FIG. 2 is a block diagram of an apparatus for creating a surveillance image with event-related information for use in an intelligent monitoring system in accordance with an embodiment of the present invention;

FIG. 3 is a block diagram of illustrating an apparatus for recognizing an event from a surveillance image for use in an intelligent monitoring system in accordance with an embodiment of the present invention;

FIG. 4 is a flowchart illustrating a process of creating an event surveillance image for use in an intelligent monitoring system in accordance with an embodiment of the present invention;

FIG. 5 is a flowchart illustrating a process of recognizing an event from an event surveillance image for use in an intelligent monitoring system in accordance with an embodiment of the present invention;

FIG. 6 illustrates an example of an event conversion table in accordance with the present invention; and

FIG. 7 illustrates an example of a supplemental enhancement information (SEI) field in accordance with the present invention.

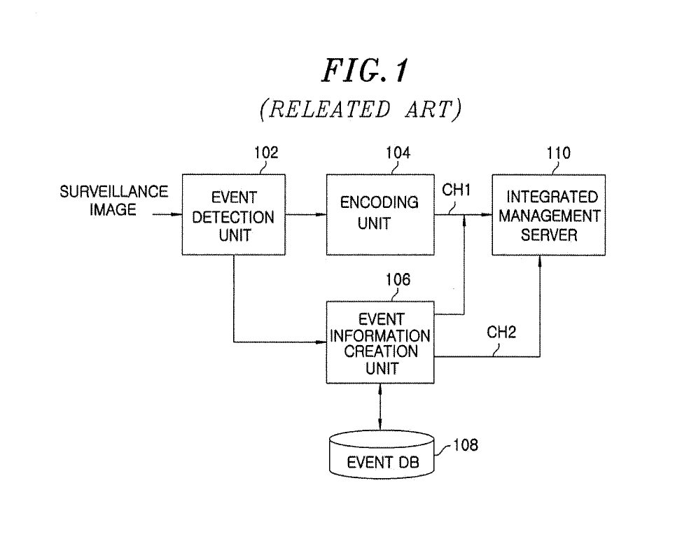

### DETAILED DESCRIPTION OF THE PREFERRED EMBODIMENTS

Hereinafter, exemplary embodiments of the present invention will be described in detail with reference to the accompanying drawings so that they can be readily implemented by those skilled in the art.

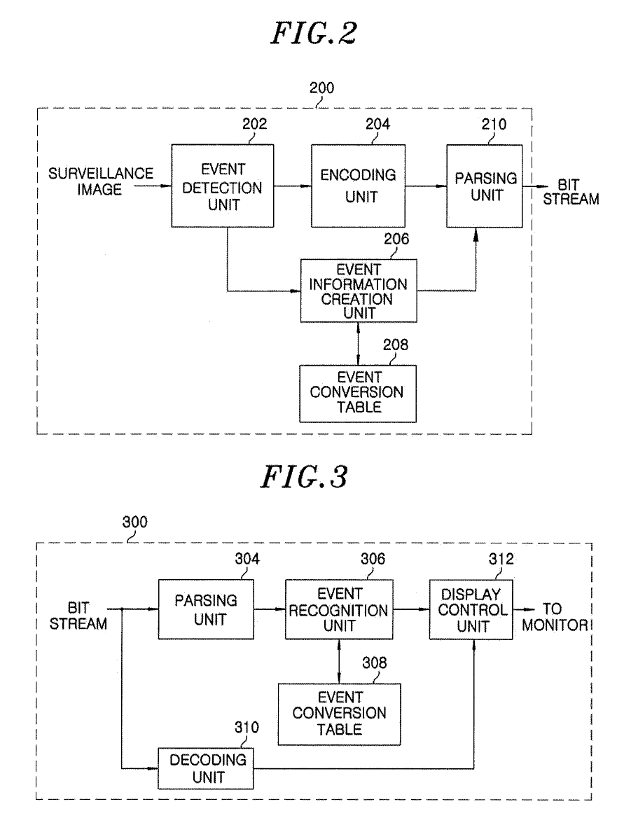

FIG. 2 is a block diagram of an apparatus 200 for creating a surveillance image with event-related information for use in an intelligent monitoring system in accordance with an embodiment of the present invention.

The apparatus 200 of the embodiment of the present invention includes an event detection unit 202, an encoding unit 204, an event information creation unit 206, an event conversion table 208, and a parsing unit 210.

A surveillance image may be obtained at a target area for surveillance using a video camera or DVR (not shown). The event detection unit 202, upon receipt of the surveillance image, detects event(s) from the surveillance image by performing on the surveillance image an image recognition technique, for example, a background modeling algorithm, an object detection and chase algorithm, an object feature parameters extraction algorithm and so on. etc.

The term ‘event(s)’ used herein refers to various types of dangerous situations, for example, such as the invasion of a restricted area by an outsider, stolen valuables, vehicle accidents, child kidnapping, fire alarms, and flooding, that may occur in a life environment.

Information on the event is transmitted to the event information creation unit 206, and the surveillance image is provided to the encoding unit 204.

The encoding unit 204 encodes the surveillance image in conformity with a preset encoding format, for example, the H.264 video format or the MPEG video format, and delivers the encoded surveillance image in the form of a bit stream to the parsing unit 210.

The event information creation unit 206 classifies the event(s) detected by the event detection unit 202 into detailed items, for example, a type of event, a danger level of event, etc based on the property of the event(s), and converts the classified event(s) into event-related information with reference to an event conversion table 208.

FIG. 6 illustrates an example of the event conversion table 208. The event conversion table 208 has a plurality of fields such as a type of event, tag, danger level, etc. The event type indicates a kind of events such as an invasion of a restricted area, stolen valuables, child kidnapping, and the like. The tag indicates codes representing a kind of the corresponding event. The danger level indicates degree of danger for the corresponding event, e.g., high, medium or low.

For example, an event, “invasion of a restricted area”, may be converted into a tag of 0×AA by the event information creation unit 206 with reference to the event conversion table 208.

The event conversion table may be configured as shown in FIG. 6, and it will be appreciated to those skilled in the art that the event conversion table 208 can be defined and used in various forms based on the properties of events.

In addition, the event information creation unit 206 may encrypt the event-related information before providing it to the parsing unit 208 such that the confidentiality of the event-related information can be secured. For this purpose, the event information creation unit 206 may include an encryption algorithm or encoder well-known in this technical field.

The parsing unit 210 parses the encoded surveillance image from the encoding unit 204, and inserts the event-related information from the event information creation unit 206 into the surveillance image. In accordance with the present invention, the event-related information is inserted into a Supplemental Enhancement Information (SEI) field in the bit stream of the encoded surveillance image, thereby creating the surveillance image with the event-related information.

For H.264/MPEG-4 AVC, the Supplemental Enhancement Information (SEI) in an image frame is extra information that can be inserted into a bit stream of the image frame to enhance the use of the video for a wide variety of purposes.

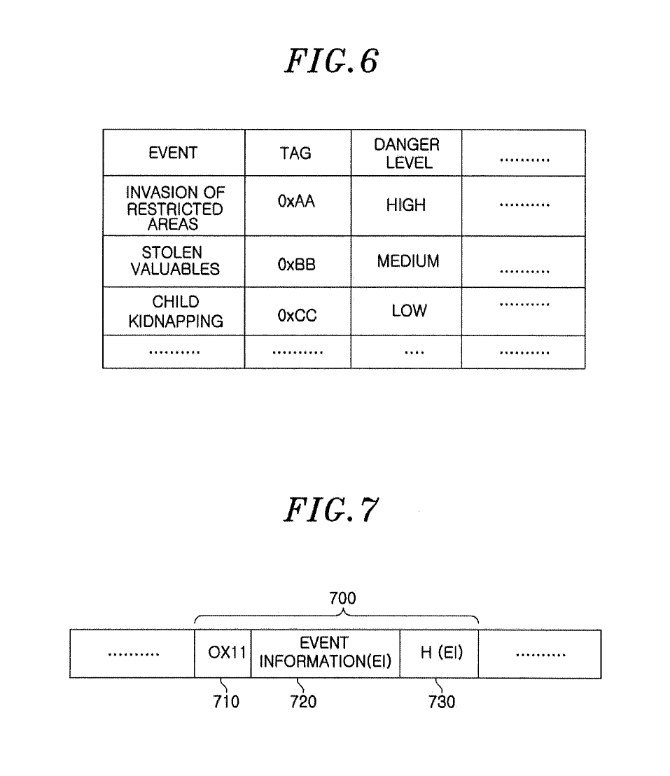

For example, a bit stream of the event surveillance image may be configured as in FIG. 7. In FIG. 7, reference numeral 700 indicates a SEI field; reference numeral 710 includes a flag indicative of the presence of the event; reference numeral 720 includes Event Information (EI) having a tag indicative of an event type; and reference numeral 730 includes a hash value (H (EI)) for integrity verification of the event-related information.

After inserting the event-related information, the parsing unit 210 transmits the surveillance image with the event-related information to an apparatus for recognizing an event from a surveillance image, which will be described with reference with FIG. 3.

FIG. 3 is a block diagram of illustrating an apparatus 300 for recognizing an event from a surveillance image for use in an intelligent monitoring system in accordance with an embodiment of the present invention.

The apparatus 300 receives a surveillance image from the apparatus 200 of FIG. 2 to recognize an event in the surveillance image.

The apparatus 300 includes a parsing unit 304, an event recognition unit 306, an event conversion table 308, a decoding unit 310, and a display control unit 312.

The surveillance image is provided to both the parsing unit 304 and the decoding unit 310.

The parsing unit 304 parses the surveillance image to determine whether or not there exists SEI field in the surveillance image. When it is determined that there exists the SEI field, the parsing unit 304 checks whether a flag has, for example, a value of “0×11” in the SEI field. When the flag is “0×11”, the parsing unit 304 stores data following the flag within the SEI field in a temporary variable. Thereafter, the parsing unit 304 extracts the hash value from the temporary variable to verify the integrity of the event-related information. When it is determined that the integrity is successfully verified, the parsing unit 304 delivers the event-related information to the event recognition unit 306 together with an integrity success instruction indicating the successful verification for the integrity.

In this case, the event-related information extracted from the SEI field might have been encrypted information in order for securing the confidentiality thereof. In order to manage such a case, the parsing unit 304 may include a decryption algorithm or a decoder capable of decrypting the encrypted event-related information back into original event-related information before encryption thereof.

The event recognition unit 306, upon receipt of the integrity success instruction, recognizes what event has been occurred by performing the conversion of the event-related information with reference to the event conversion table 308, and provides the recognized result to the display control unit 312 together with the event-related information.

In this regard, the event conversion table 308 is the same as the event conversion table 208 of FIG. 2. Further, an alarm signal may be appended to the search result, which is used to notify a manager that a dangerous situation or accident has occurred, for example, to sound an alarm or to display an event occurrence or warning expression on a monitor.

The decoding unit 310 extracts a surveillance image from the event surveillance image and provides the surveillance image to the display control unit 312.

Finally, the display control unit 312 combines the decoded surveillance image with the event-related information to generate a combined surveillance image in which the event-related information is combined with the surveillance image. The combined surveillance image may be provided to a monitor (not shown) that the event occurrence or warning expression is presented to a manager.

Therefore, the apparatus for recognizing event-related information in accordance with the present invention may effectively recognize what event has been occurred based on the event-related information in the SEI field of the event surveillance image.

Meanwhile, although the detailed description of the present invention has been made such that the apparatus 200 of FIG. 2 and the apparatus 300 of FIG. 3 are configured separately in the embodiment of the present invention, it is merely an example for the sake of explanation and to improve the understanding and the present invention is not limited thereto. It will be appreciated to those skilled in the art that the apparatuses 200 and 300 of FIGS. 2 and 3 may be configured within a single intelligent surveillance system.

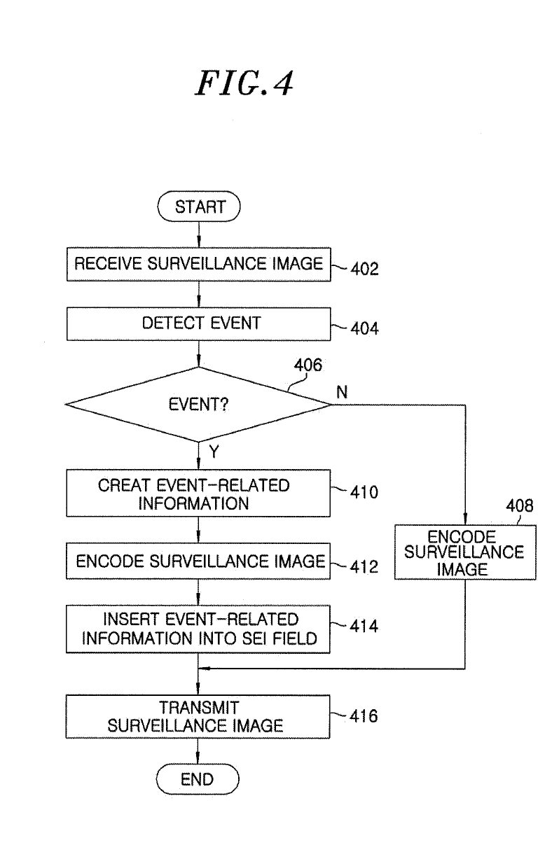

FIG. 4 is a flowchart illustrating a process of creating an event surveillance image in accordance with the embodiment of the present invention.

Referring to FIG. 4, when a surveillance image is received at step 402, the event detection unit 202 scans the surveillance image to detect an event from the surveillance image at step 404.

At step 406, it is determined whether or not any event is detected in the surveillance image. If it is determined that none event is detected, the process goes to step 408, and if it is determined that any event is detected, the process then advances to step 410.

At step 408, the surveillance image is provided to the encoding unit 204 where the surveillance image without the event-related information is encoded. Thereafter, at step 416, the encoded surveillance image without the event-related information will be transmitted to the apparatus of FIG. 3 in the form of a bit stream via the frame parser 210.

Meanwhile, at step 410, the event information creation unit 206 classifies the detected event into detailed items, such as a type of event, danger level and so on based on the properties of the event, converts information on the event into an event-related information with reference to the event conversion table 208, and then provides the event-related information to the parsing unit 210.

At step 412, the encoding unit 204 encodes the surveillance image in which the event has been detected. The encoded surveillance image from the encoding unit 204 is then provided to the parsing unit 210.

Next, at step 414, the parsing unit 210 parses the encoded surveillance image and inserts the event-related information from the event information creation unit 208 into a SEI field in the bit stream of the encoded surveillance image, thereby generating the surveillance image with the event-related information. Subsequently, at step 416, the surveillance image with the event-related image will be transmitted to the apparatus 300 of FIG. 3.

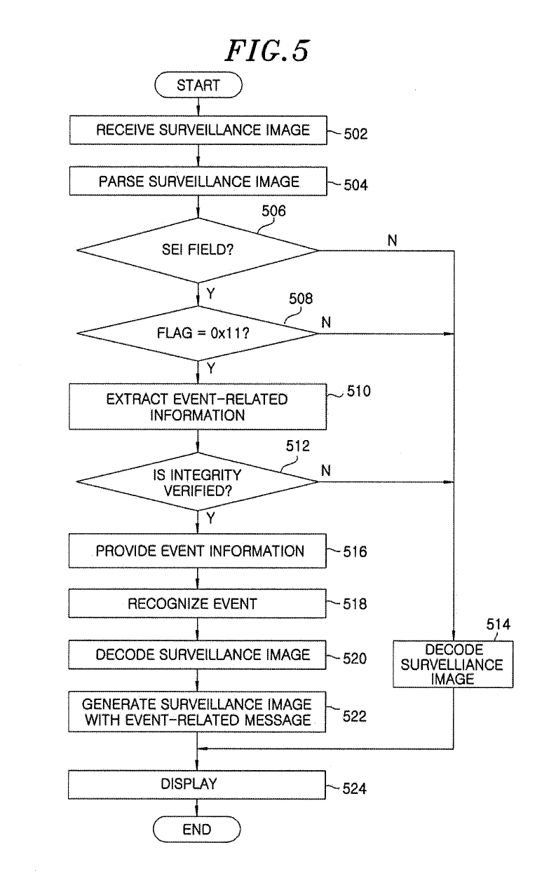

FIG. 5 is a flowchart illustrating a process of recognizing an event from an event surveillance image in accordance with the embodiment of the present invention.

First of all, at step 502, a surveillance image with/without event-realted information is received by the apparatus 300 shown in FIG. 3.

Next, the parsing unit 304 parses the surveillance image at step 504 and determines whether or not an SEI field exists in the bit stream of the surveillance image at step 506.

If the SEI field does not exist in the surveillance image, the process advances to step 514 where the decoding unit 310 decodes the surveillance image back into an original surveillance image before the encoding thereof, and then delivers the decoded surveillance image to the display control unit 312. Thereafter, at step 524, the display control unit 312 provides the decoded surveillance image to a monitor so that the surveillance image without the event-related information is displayed on the monitor.

If, however, it is determined that the SEI field exists in the surveillance image, the process goes to step 508. In step 508, the parsing unit 304 checks whether the value of a flag in the SEI field is, for example, “0×11”.

If, as the result of the check at step 508, it is checked that the value of the flag is “0×11”, the process goes to step 510. In step 510, the parsing unit 304 stores the event-related information in a temporary variable, and verifies the integrity of the event-related information using the hash value stored in the temporary variable.

Thereafter, at step 512, the parsing unit 304 determines whether or not the integrity is successfully verified. If it is determined that the verification of the integrity failed, the process goes to above-described step 514.

If, however, it is determined that the integrity was successfully verified, the process proceeds to step 516 in which the parsing unit 304 notifies the event recognition unit 306 of the successful verification.

Subsequently, at step 518, the event recognition unit 306 recognizes an event that has been occurred in the surveillance image using the event-related information by performing the conversion of the event-related information with reference to the event conversion table 308, and then provided the recognized result to the display control unit 312 along with the event-related information.

Meanwhile, at step 520, the decoding unit 310 decodes the surveillance image with the event-related information and then transmits the decoded surveillance image to the display control unit 312.

After that, at step 522, the display control unit 312 combines the decoded surveillance image with the recognized event to thereby generate the surveillance image with an event-related message, and then transmits the surveillance image with the event-related message to the monitor.

Accordingly, at step 524, the monitor displays the surveillance image with the event-related message at step 524.

In this regard, the event-related message may include information about the event occurrence or warning expression.

As described above, in accordance with the present invention, event-related information is inserted into a SEI field of a surveillance image, without using an additional header file or metadata, thereby realizing an epoch-making reduction in the expense and time required to construct an intelligent monitoring system.

Further, the present invention may also be applied to existing security systems by performing a minimum of modifications on a program without using an additional operating system or database, thereby reducing the time and expense required to implement the security system.

While the invention has been shown and described with respect to the preferred embodiment, it will be understood by those skilled in the art that various changes and modifications may be made without departing from the scope of the invention as defined in the following claims.

What is claimed is:

1. An apparatus for creating a surveillance image with event-related information, the apparatus comprising:
an event detection unit configured to detect an event in the surveillance image;
an encoding unit configured to encode the surveillance image into a bit stream of the surveillance image;
an event information creation unit configured to create event-related information based on the detected event; and
a parsing unit configured to parse the encoded surveillance image and insert the event-related information into the bit stream of the encoded surveillance image.

2. The apparatus of claim 1, wherein the event-related information is inserted into a Supplemental Enhancement Information (SEI) field of the bit stream.

3. The apparatus of claim 2, wherein the event information creation unit is further configured to classify the event into a type of event and a danger level of event based on the properties of the event,
wherein the apparatus further comprises an event conversion table configured to convert the classified event into the event-related information.

4. The apparatus of claim 2, wherein the event-related information includes a flag indicative of the presence of the event, a type of the event, and a danger level of the event.

5. The apparatus of claim 4, wherein the event-related information further includes a hash value for the verification of the integrity of the event-related information.

6. The apparatus of claim 2, wherein the event-related information is encrypted information.

7. A method for creating a surveillance image with event-related information, the method comprising:
detecting an event in a surveillance image using an intelligent image recognition technique;
encoding the surveillance image to produce a bit stream of an encoded surveillance image;
parsing the encoded surveillance image; and
inserting event-related information corresponding to the event into the bit stream of the encoded surveillance image.

8. The method of claim 7, wherein the event-related information is inserted into a Supplemental Enhancement Information (SEI) field in the bit stream.

9. The method of claim 7, further comprising:
classifying the event into a type of event and a danger level of event based on the properties of the event; and
converting the classified event into the event-related information.

10. The method of claim 7, wherein the event-related information includes a flag indicative of the presence of the event, a type of the event, and a danger level of the event.

11. The method of claim 10, wherein the event-related information further includes a hash value for the verification of the integrity of the event-related information.

12. The method of claim 8, wherein the event-related information is encrypted information.

13. An apparatus for recognizing an event from a surveillance image, the apparatus comprising:
a parsing unit configured to parse the surveillance image to determine whether or not there exists a Supplemental Enhancement Information (SEI) field in the surveillance image;
an event recognition unit configured to recognize the event in the surveillance image based on the SEI; and
a display control unit configured to display event-related information corresponding to the event on a monitor together with the surveillance image.

14. The apparatus of claim 13, wherein the event recognition unit is further configured to convert the event-related information into a type of the event and a danger level of the event with reference to an event conversion table.

15. The apparatus of claim 13, wherein the event-related information further includes a hash value,
wherein the parsing unit is further configured to verify the event-related information using the hash value.

16. The apparatus of claim 13, wherein the event-related information is encrypted information and the parsing unit is further configured to decrypt the encrypted event-related information before the conversion of the event-related information.

17. A method for recognizing an event from a surveillance image, the method comprising:
receiving a bit stream of a surveillance image;
checking whether or not there exists a SEI field having event-related information in the surveillance image;
when the SEI field exists, extracting the event-related information from the SEI field to recognize the event that has been detected in the surveillance image based on the event-related information.

18. The method of claim 17, further comprising:
converting the event-related information into a type of the event and a danger level of the event with reference to an event conversion table.

19. The method of claim 17, wherein the event-related information further includes a hash value,
the method further comprising:
verifying the event-related information using the hash value.

20. The method of claim 17, wherein the event information is encrypted information,
the method further comprising:
decrypting the encrypted event-related information before the conversion of the event-related information.
